(19) United States
(12) Patent Application Publication
(10) Pub. No.: US 2018/0349824 A1
(43) Pub. Date: Dec. 6, 2018

(54) DETERMINING A PRODUCTION PLAN

(71) Applicant: SIEMENS AKTIENGESELLSCHAFT, Munchen (DE)

(72) Inventors: Rafael Fink, MUNCHEN (DE); Florian Seipp, MUNCHEN (DE)

(21) Appl. No.: 15/975,805

(22) Filed: May 10, 2018

(30) Foreign Application Priority Data
May 31, 2017 (EP) 17173626.7

(51) Int. Cl. G06Q 10/06; G06Q 10/04

(52) U.S. Cl. CPC G06Q 10/06313; G06Q 10/04

(57) ABSTRACT

Provided is a method to determine a production plan including steps to identify production means, to identify at least one product for each production means, which can be manufactured with the aid of the production means; to identify at least one raw material required for its production for each product; to identify which of the products is used as a raw material for which other product; to model the identified circumstances as MIP; and to determine a solution to the MIP. Thereby, the solution is optimized to the furthest extent possible with regard to at least one predetermined parameter and indicates which product at which time should be manufactured with the aid of which production means and based on which raw material.

### CROSS-REFERENCE TO RELATED APPLICATION

This application claims priority to European Application No. 17173626.7, having a filing date of May 31, 2017, the entire contents of which are hereby incorporated by reference.

### FIELD OF TECHNOLOGY

The following relates to the determination of a production plan. In particular, the following relates to the determination of an optimized production plan in order to operate a production system based upon it.

### BACKGROUND

A production system comprises a plurality of production means that are set up to respectively manufacture a product based upon at least one raw material. The product can also be used as a raw material for another production means. In order to be able to provide products at a predetermined point in time, the production means must be suitably operated in a timely manner, for which the preceding operation of other production means is required under certain circumstances.

A production means usually has a limited production capacity, which, for example, in the case of a machine, can be expressed in units per hour. Generally, a plurality of different products should be manufactured via the production means so that a plan must be made concerning which product in what quantity and at what time should utilize the production means. The determination of a production plan is difficult if all the products' requirements on a production means draw near to the production capacity or exceed this.

Various solutions exist to determine a timely sequence of the operation of all required operating resources and for the requirements planning for the external procurement of raw materials. Usually, “backward planning” is carried out, which merely aims to provide a predetermined quantity of products at a predetermined time. This backward scheduling can then result in capacity conflicts, which frequently cannot be solved by heuristics or cannot be solved in good quality.

### SUMMARY

An aspect relates to an improved planning for the operation of a production system.

A method to determine a production plan comprises steps to identify production means, to identify for each production means at least one product which can be manufactured with the aid of the production means; to identify for each product at least one raw material that is required for its production; to identify which of the products is used as a raw material for which other product; to model the identified circumstances as MIP; and to determine a solution to the MIP. Thereby, the solution is optimized to the furthest extent possible with regard to at least one predetermined parameter and indicates which product at which time should be manufactured with the aid of which production means and based on which raw material, and within which step of a variety of time steps.

MIP stands for Mixed Integer Programming and describes a technique to solve an optimization problem. Thereby, at least one part of the input variables must fulfill integrality constraints and relationships between the used variables are linear. If there are no integrality constraints, LP (linear programming) is also referred to.

For MIP, an optimization problem in the form of variables, dependencies of the variables, constraints for the variables and one or a plurality of optimization factors is formulated. A solution for the defined MIP can be determined by means of a known solution program (“solver”), for example, Cplex, Gurobi, SCIP or XPRESS. For the determination sequence of the solution program, an indication can be made on which parameter must be minimized or maximized (“objective function”) and how the quality of a solution should be determined as a linear combination of any parameters of the optimization problem.

By means of MIP, a solution can usually be provided quickly for the runtime, which fulfills all the set conditions (“feasible solution”). Usually, the quality of the provided solution increases if the determination program runs for a longer period of time. For each solution, it can be determined how far away its quality is from a theoretically achievable quality of an optimal solution (“gap”). The solution program can be stopped when the determined solution is deemed to be adequately good. Provided there is sufficient runtime, MIP always finds an optimal solution if there is a solution at all.

By means of MIP, all significant parameters and relationships of the production system can be modeled and simultaneously be taken into consideration when determining a solution so that an optimized solution can be found in various respects. Any status of the production system can be taken into consideration, which may have resulted, for example, from a preceding operation. The production system can be viewed as a whole together with products or raw materials so that an improved production plan can be determined.

For example, at the same time, a production volume can be maximized and production costs can be minimized. Thereby, practically any relationships or characteristics of the production system can be formulated and taken into consideration. Thereby, the determined solution can deliver improved results when the production system is in operation. The practical applicability of the determined solution can be increased.

For each production means, a production capacity can be predetermined, which indicates how many products can be processed by means of the production means within a predetermined time slice. In other embodiments, a production capacity can also be indicated in units, meters, square meters, kilograms, liters or another unit. Usually, different products must share the production means, wherein, frequently, the production capacity of the production means is not sufficient to process all the desired products in the sufficient quantity or quality. Devising a solution can then be very cumbersome. Therefore, for each product, a production capacity utilization of the production means can be determined, which indicates how much of the production capacity of the production means is utilized by the product. The sum of the utilization of all products that should be processed on the production means within the time slice must not exceed the predetermined production capacity. The solution can be determined so that this auxiliary condition is surely fulfilled.

Production capacities of the production means are usually specified or can easily be determined in advance. The utilization of the production means by the various products, in particular, the sum of the utilization of all products, can be determined for each production means in an appropriate manner.

By taking the production capacity into account, it can be ensured that the determined solution is realistic and can be implemented on the production means. A breakdown of a required capacity of a product into a plurality of production means or a plurality of batches, which are successively processed on the production means, can be supported. In an embodiment, a changeover time is also taken into consideration if the production means must be changed over from the processing of a first product to the processing of a second product, for example, because a tool must be replaced or a setting must be changed. In this time, the production means are usually not available for the production process.

A location can be assigned to a production means, a product inventory and/or a raw-material inventory. Thereby, transporting a raw material or a product from one location to another can be taken into consideration, in particular with reference to the required duration for this. The consideration can be measured in time and/or transport capacity.

By means of this, the circumstance can be taken into consideration in an improved manner that raw materials and/or products must frequently be moved to a considerable extent between various production means in order to be able to finalize a higher-level product. In particular, this applies to a distributed production system, where a transport across multiple locations, country borders or continental borders must take place. By taking the location into consideration, just-in-time production can be supported, as it usually is, for example, in the production of automobiles.

In a simple embodiment, transport times and/or transport costs can be taken into consideration. In another embodiment, other additional characteristics of a transport means, for example, of a truck, a train or a ship, can be taken into consideration. Transport characteristics can, for example, comprise a transport duration or a minimum and/or maximum amount of objects to be transported. By means of this, for example, it can be taken into consideration that a ship can transport a very large amount of objects however, for quick loading and clearing, great connection capacities or storage facilities are required.

At least one storage facility can be provided to admit a raw material, product or operating equipment, wherein a capacity can be assigned to the storage facility, which must not be exceeded. The determined solution can ensure that the capacity is not exceeded. Where appropriate, it can be indicated as an optimization condition, how the capacity of the storage facility should preferably be used, for example subject to minimizing warehouse admissions or removals (for example in a cold storage facility) or subject to striving for a predetermined storage inventory.

The storage facility can be assigned to a production means and a location can be assigned to the storage facility. Transport operations to or from the storage facility can be better planned by means of this. A transport operation can last a predetermined time, which can be taken into consideration in order to ensure a predetermined minimum shelf-life, for example, or to provide support for a waiting process (e.g. in order to allow a product to ripen).

The production plan can be created for one or m successive time steps. By means of this, it can be modeled what sequence raw materials must be processed into products and these must continue to be processed into other products. In particular, how the operation of the production system, for example, depending on a desired output of products, is startup or shutdown can be modeled. The production plan can be practically determined for any number of time steps m. Thereby, the time steps are usually respectively identical in size.

In another embodiment, a new production plan is created every n time steps. This can, once again, affect m following time steps. Thereby, n<=m preferably applies so that a new determination is carried out even before the previously determined production plan has been completely executed. This approach can also be referred to as rolling planning. An existing production plan for future time steps can be respectively replaced by the most current production plan. In the case of every optimization run, a present status, which has been assumed due to the operation of the production system according to a previously determined production plan, can be used as an initial status. By means of this, improved regulation can be achieved.

Due to newly cyclically executed determination of the production plan, in particular, changes in the specifications, which have resulted since the last determination, can be taken into consideration. If for example, a transport problem arises in the meantime, if a raw material is not available as previously planned, or if product output should be increased or decreased, the respectively applicable production plan can be adapted in an efficient and prompt manner due to its cyclical determination. In an embodiment, the determination of a new production plan is newly carried out at every time step.

The time steps are usually respectively identical in size. It is preferred that the method is used for rough planning, which can be connected downstream to a detailed planning of individual determined production objectives. In the rough planning, time steps in days, weeks, months or multiples thereof have proven their validity. Longer periods of time can also be covered by a time step. The greater the time steps are, the less uncertainties with regard to individual parameters in determining the solution carry weight. However, the achievable quality of the solution can also be decreased since the specified restrictions must also be adhered to in the case of parameter fluctuations. If, for example, the delivery of a required raw material only takes place on an irregular basis, the fluctuation can be reduced by simplifying the time pattern. The fluctuations can also be compensated for by means of a storage facility so that more storage capacity must be planned in under certain circumstances.

A maximum shelf-life can be assigned to a product, wherein the production plan is created in such a way that the product is processed or provided with a predetermined minimum shelf-life. A shelf-life can also be assigned to a raw material. Taking the shelf-life into consideration can, for example, be of crucial significance in the production of foods. By taking the predetermined minimum shelf-life of the finished product into consideration, the lead-time of a component or a material of the product can also be taken into consideration by the production system. Furthermore, it can be ensured that such products or raw materials with the least amount of remaining shelf-life are preferably further processed or output. A spoiling of a raw material or a product can be avoided.

A predetermined waiting time can be assigned to a product or raw material, wherein the production plan is created in such a way that the product or the raw material is not further processed or provided before the waiting time expires. By means of this, a ripening process, a cooling process, a fermentation process or a chemical process such as hardening, binding or curing can, for example, be taken into consideration. Glowing steel, for example, cannot be transported before it has become sufficiently solid by means of cooling. Along a production chain, variously long waiting times can be added at various points.

In addition, at least one consumable material can be taken into consideration that is required for the operation of a production means. For example, for the operation of a production means that comprises an oven, a fuel can be required as a consumable material. The procurement, the storage and the transport of the consumable material can also be taken into consideration according to that which has been stated above. In addition, for example, a location, a batch size, a waiting time or a shelf-life can be assigned to the consumable material. The consumable material can also comprise a product that has been manufactured at a preceding point of the production process. In general, the consumable material can also be considered along the same lines as a raw material.

In other embodiments, one or a plurality of auxiliary conditions may be upheld, which provide for the implementability and the practical applicability, however can make finding an appropriate solution difficult at the same time.

For example, the solution can be determined in such a way that a predetermined minimum production quantity, which indicates what quantity of a product must be at least processed at a production step, is upheld. By means of this, an excessively frequent change of products to be processed on a production means can be avoided. A production step usually corresponds to processing on a production means.

In another example, the solution can be determined in such a way that a predetermined batch size, which indicates a quantity of a product, of which an integral multiple must be processed at a production step, is upheld. Logistic processes during production can be better supported by means of this.

A computer program product (non-transitory computer readable storage medium having instructions, which when executed by a processor, perform actions) comprises program-code means to carry out the aforementioned method, if the method runs on an executing means or is stored on a computer-readable medium. In particular, the method can be fully or partly carried out by means of a processing device. The processing device preferably comprises a programmable microcomputer. Advantages or features of the method can be transferred to a device, which comprises such a processing device, and vice versa.

A device to determine a production plan comprises a processing device, which is set up to carry out the aforementioned method, in particular, to determine a solution of an MIP. Thereby, the MIP is defined based on the production means; products respectively assigned to the production means, which can be manufactured with the aid of the production means; raw materials, which are required for the production of the products, assigned to the products; and dependencies, which report which of the products is used as raw material for which other product. The solution is optimally determined to the furthest extent possible with regard to at least one predetermined parameter and indicates which product at which time should be manufactured by means of which production means and based on which raw material.

A production system comprises a plurality of production means, with the aid of which at least another product can be manufactured from at least one raw material or product respectively; and the device described in the above. The method described in the above can be used for the production planning for the production system. In an embodiment, the method comprises the control or operation of at least one part of the production system according to a specification of the previously determined production plan.

### BRIEF DESCRIPTION

Some of the embodiments will be described in detail, with reference to the following figures, wherein like designations denote like members, wherein:

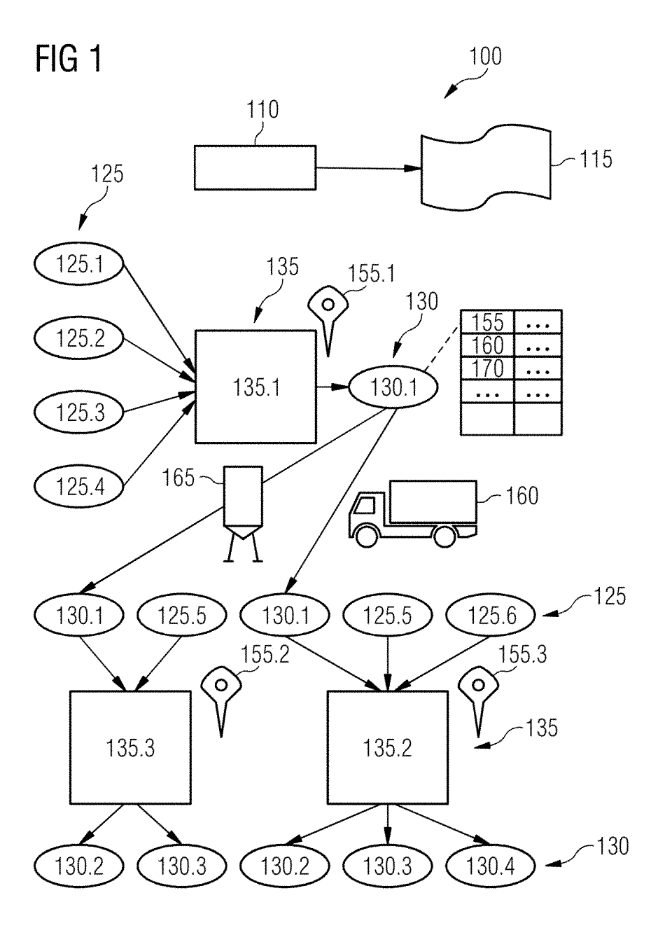

FIG. 1 shows an exemplary system, in accordance with embodiments of the present invention;

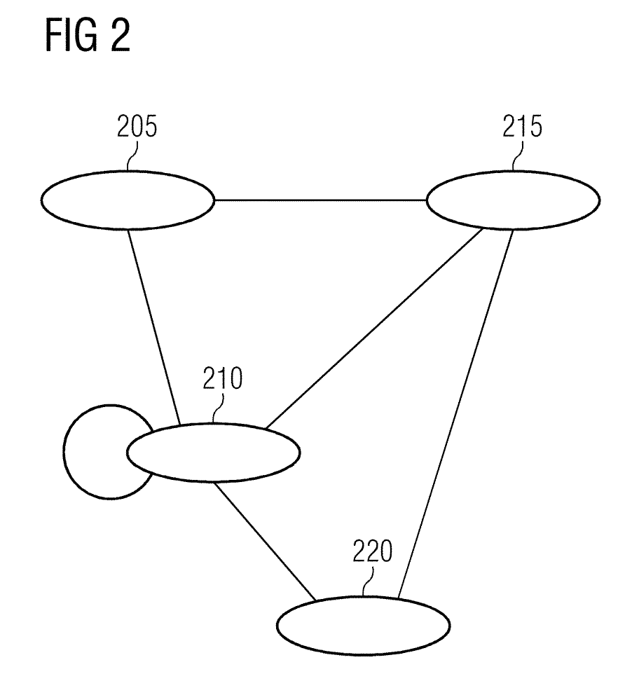

FIG. 2 shows influencing factors of an MIP, in accordance with embodiments of the present invention;

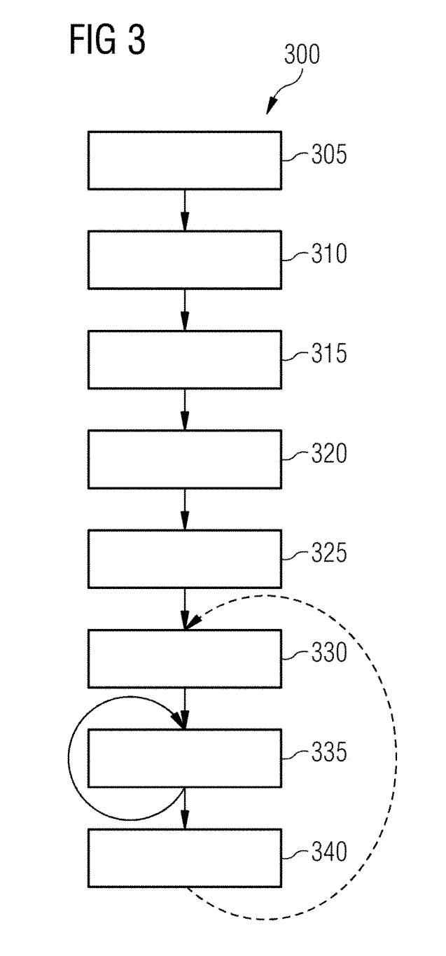

FIG. 3 shows a flowchart of a method to determine a production plan, in accordance with embodiments of the present invention;

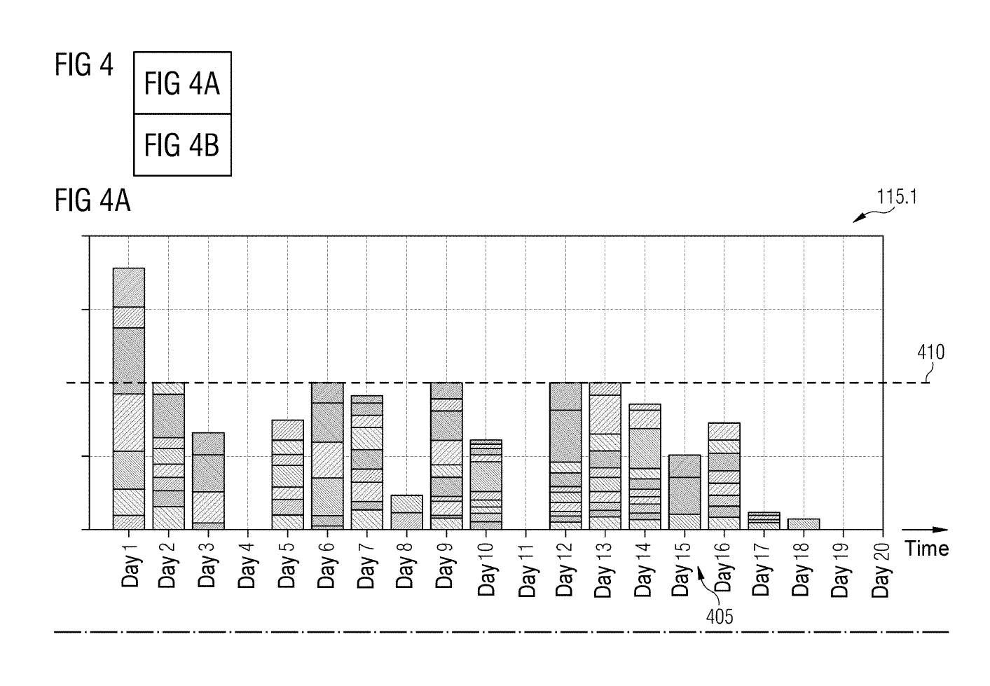

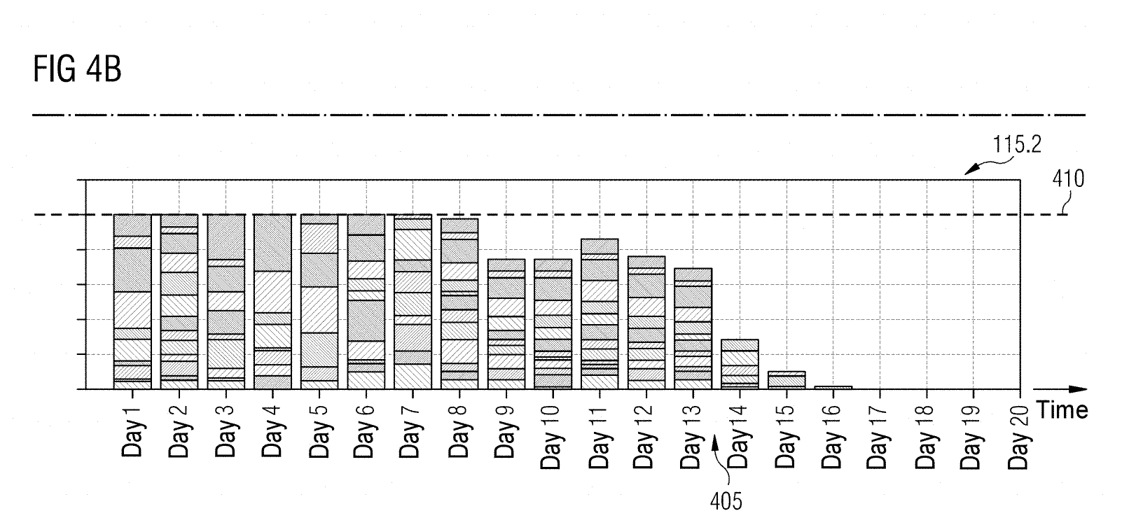

FIG. 4A shows an exemplary production plan, in accordance with embodiments of the present invention; and

FIG. 4B shows an exemplary production plan, in accordance with embodiments of the present invention.

### DETAILED DESCRIPTION

FIG. 1 shows an exemplary system 100, which comprises a production system 105 and a device 110 to determine a production plan 115. The production plan 115 should indicate how the components of the production system 105 should be used depending on at least one parameter and/or at least one optimization criterion. The production system 105 is set up to manufacture at least one product 135.

For the following description, a production system 105 to produce pretzels is used as an example. Only features referring to the example in FIG. 1 have a reference number with a numerical suffix separated by a point (e.g. “123.4”). Features without a suffix can respectively comprise all examples with a suffix.

In general, within the production system 105, one or a plurality of raw materials 125 are processed (here: water, 125.1, salt 125.2, yeast 125.3 and flour 125.4) into a product 130 (here, initially into a raw pretzel 130.1), for which a production means 135 is used (here a dough-processing machine 135.1, which can be set up, for example, in an industrial bakery). The manufactured product 130 can be used as a raw material 125 for a subsequent production step.

In the example shown, the raw pretzel 130.1 can be baked into a finished pretzel 130.2 by means of a first oven 135.2, which can be set up in a first bakery branch. By adding poppy seeds 125.5 beforehand, a poppy-seed pretzel 130.3 can also be made from the raw pretzel 130.1 or, by adding cheese 125.6, a cheese pretzel 130.4 can be made. The finished pretzel variations 130.2, 130.3 and 130.4 of both ovens 135.2, 135.3, are not further processed as raw materials 125 within the production system 105, but provided as finished products.

In a second oven 135.3, the second production step can also be carried out. However, for this, only the production of pretzels 130.2 and, by adding poppy seeds 125.5, poppy-seed pretzels 130.3 is provided.

A location 155 can in each case be assigned to each raw material 125, each product 130 and each production means 135. The production means 135 are usually stationary, the other objects can be transported between locations 155 via a transport means 160. At both locations 155.2, 155.3, only one oven 135 is respectively available, which is required to finish the products 130.2 to 130.4. If, for example, the oven 135.3 is occupied at the first location 155.2 by a load of poppy-seed pretzels 130.3, a load of plain pretzels 130.2 must wait until they can use the oven 135.3. The oven 135.2 represents a limited production means, which only has a predetermined production capacity. The overall capacity of the production system 100 can be limited by the production capacity of the oven 135.

Performance is similar in the case of the dough-processing machine 135.1: no more raw pretzels 130.1 can be produced within a predetermined time than the production capacity of the dough-processing machine 135.1 allows.

The production process shown for pretzels 130.2 to 130.4 has multiple steps, like most of the real production processes. At a first step, each pretzel 130.2 to 130.4 requires the production of a raw pretzel 130.1 in the dough-processing machine 135.1, and at a second step, baking the raw pretzel 130.1 in an oven 135.2, 135.3. The maximum production capacity of a later step cannot be fully utilized under certain circumstances if not enough products 130 are made available at an earlier step that should be processed at the subordinate step.

The planning of which production means 135, at what time, with the processing of what quantities of what product should be used can become complex due to such dependencies. Furthermore, the planning can furthermore be made difficult by a raw material 125 or a product 130 possibly requiring a predetermined time in order to run through a production means 135. The time between finishing two products 130 is normally different from the lead-time of a raw material through the production means 135.

If, for example, the flour 125.4 runs out on the dough-processing machine 135.1, raw pretzels 130.1 can still be output for a certain amount of time. If new flour 125.4 is provided, it may take another predetermined time period before new raw pretzels 130.1 can be produced again. The downtime of a production means 135 can cause the downtime of another production means 135 so that starting up the production system 105 can be laborious and complex.

Attributes such as a transport capacity or a transport duration can be assigned to the transport means 160. Other attributes can be taken into consideration or left up to a detailed planning. An object 125, 130 can be stored in a storage facility 165, wherein attributes, such as a storage capacity, a maximum storage duration, storage costs or access times can be assigned to the storage facility 165. Besides their location 155, attributes such as a production duration per product 130, an output of products 130 per time unit or production costs per product 130 can also be assigned to each production means 135.

One or a plurality of time attributes 170 can be assigned to a raw material 125 or product 130. For example, a production time, a time window for the use of a piece of operating equipment or a guaranteed minimum shelf-life can be managed. Certain raw materials 125 or products 130 must ripen between production steps; a ripening duration to be upheld or expiring shelf-life can also be used as attributes. Furthermore, there can be other product attributes, which limit the manufacturable quantities, e.g. minimum production quantities or batch sizes. In the above example, for example, 20 raw pretzels 130.1 per baking tray, which is processed in the oven 135.2, could always be provided, wherein only partially occupied baking trays are not allowed.

The predetermined elements and attributes can be expressed as parameters of an MIP. Relationships between the elements and attributes can be expressed by preferably linear equations. Conditions to be adhered to can, for example, be modeled as Boolean or numerical specifications. In addition, target specifications can be expressed, such as a desired output of products 130, the timely delivery of customer demands or a desired utilization of a storage facility 165. Boundary conditions, such as an availability of a certain raw material 125 at a certain location 155 can be set as a parameter.

An exemplary specification concerns the minimal production volume of a product 130 on a production means 135. In addition, it is mathematically expressed that, for the production of a certain product 130 at a certain time step (cf. below with reference to FIG. 4) on a certain production means 135, at all time steps 405, the produced quantity of products 130 must be greater than the lower limit of the production volume for this product 130 on this production means 135.

x(p,r,t)≥y(p,r,t)·M(p,r) for all pEP, rER, tET
whereby the following significations are given:
P quantity of products 130
R quantity of production means 135
T number of time steps
M parameter matrix
M(p,r) lower limit of the production volume for the production of the product p on a production means rx(p,r,t) quantity of products p, which are manufactured on a production means r at the time step t;
y(p,r,t) 1, if the product p is manufactured on the production means r at a time step t, and otherwise 0

Corresponding definitions or boundary conditions can also be indicated for all other required variables or relationships of an MIP.

FIG. 2 shows the various types of influencing factors of an MIP, which models a production system 105. Together, concrete instances of the individual influencing factors then yield the MIP planning instance. A first influencing factor 205 concerns production means 135, a second influencing factor 210 concerns products 130, a third influencing factor 215 concerns the planning horizon broken down into time slices and a fourth influencing factor 220 concerns product demands. These influence factors are predetermined by related attributes and parameters in a more precise manner:
for the first model influencing factor 205 “production means”:
capacities (quantity, volume, time, mass)
assignment of resource groups
calendars, which specify the availability/capacities of resources
for the second model influencing factor 210 “products”:
capacity type (units per time period; changeover time; weight per unit)
calendar (when are products allowed to be produced and sold)
options of the production means (preferences that express that it is preferred that, for example, the cheese pretzel is finished in bakery 1 rather than bakery 2)
minimum production volume
batch or lot size
material list of the required raw materials 125 and products 130, meaning product structure
waiting time and finishing duration (for further processing and delivery to end customers)
minimum shelf-life

Inventory range (meaning the quantity of time slices, across which a production can be maintained based on inventories), for example, minimal, maximal or as a target specification for a predetermined value depending on the requirements during the next time slices. For example: “Always hold available the complete demand of raw materials for the production over the next three days.”
for the third model influencing factor 215 “planning horizon”, broken down into time slices:
Day (index) of the time slices
Capacity in hours/number of hours per time slice
for the fourth model influencing factor 220 product demand:
required product 130
required quantity
delivery time
orders or predicted requirements

Thereby, parameters of different model influencing factors 205-220 can determine or influence each other. For example, the minimum shelf-life of the second model influencing factor 210 and the delivery time of the fourth model influencing factor 220 can determine each other.

Dependencies between variables of different model influencing factors 205-220 can exist. For example, in the case of the exemplary production system 105 in FIG. 1, batch sizes for the ovens 135.2 and 135.3 can be specified, wherein the batch sizes respectively indicate how many raw pretzels 130.1 are baked during one work process. The batch size of the first oven 135.2 can be bigger than that of the second oven 135.3, for example, because the oven 135.2 is larger than the oven 135.3. Here, a variable of the production-means-model influencing factor 205 (the oven) determines a variable of the product-model influencing factor 210 (the batch size).

Due to the described determinations of the parameters and the auxiliary conditions associated with them, for the MIP instance, a search area is defined, in which a solution can be found, which contains all specifications, relationships and restrictions and thereby, a desired parameter is optimized to the furthest extent possible. This factor, for example, can concern the maximization of the fulfilled order volume, the minimization of production costs or the maximization of a temporal utilization of a production means 135. Other examples for elements of a factor to be optimized comprise
timely fulfillment of orders or predicted requirements
minimization of a demand coverage that is earlier or later than specified
transport costs
storage costs
production preferences
incentives for remaining production capacities (flexibility).

The number of parameters that can be varied in order to arrive at different solutions is usually already very large in a simple example, and the dependencies are complex. In a conventional way, an approximate solution is frequently determined, which should then be manually improved by using heuristics. For this, substantial human intermediate work can be required and often, it is not known how close the quality of the reached solution is to an achievable quality.

By means of a solver, an MIP, which represents the problem, can be solved in a shorter period of time and the solution can be optimized. In addition, the quality of the determined solution can be determined by means of a specified equation, which can take one or a plurality of target criteria, optionally weighted, into consideration. The relative quality of the determined solution in comparison with an achievable quality (“gap”) can always be known.

By viewing the production system 105 as an integral problem, finding a solution can also be carried out in an efficient manner across a very large search area with the help of a computer. Thereby all information that is characteristic of a production process can be taken into consideration and the solution can be optimized with reference to any specification, even a plurality of specifications. By taking into consideration the production capacities of the production means, time parameters and/or modeling of locations, between which objects must be transported, a very practically and rapidly applicable solution can be found in the form of a production plan.

FIG. 3 shows a flow chart of a method 300 to determine a production plan 115. The method 300 is set up to run on a device 110, which can particularly comprise a computer, preferably with a software for solving MIP.

At one step 305, production means 135, which allow a processing or production of products 130 by means of the production system 105, and preferably also the production capacities of the production means 135 are determined. At one step 310, at least one product 130 to be produced is determined. At one step 315, a determination is made for each of the products 130 to be produced on which raw materials 125 are required for their production. Accordingly, at one step 320, a determination can be made on which of the products 130 are intermediate products and should be used as a raw material 125 for a subordinate production step.

At one step 325, the production system 105 is modeled as an MIP. In addition, for example, restrictions, functions or relationships can be mathematically expressed as they are described in the above. For this, in particular, several or all of the attributes of the model influencing factors 205, 210, 215 and 220 described above can be required.

At one step 330, the MIP can be parametrized. In addition, for example, preferences can be indicated for the determination of the production plan 115.

If the method 300 has already been previously carried out, parameters, which have been determined on the production system 105 can be updated for a new run. For example, the method can be executed a first time and the production system 105 can be operated based on the production plan created in the process. Before the method 300 is executed a second time, it can be checked if a target value, for example, with regard to an inventory of a product 130, which would be expected due to the production plan, is also actually available. The second run of the method 300 then takes place in an improved manner based on the actual value determined on the production system 105.

At one step 335, the MIP is solved, meaning a combination of variable values is searched for within the existing search area, which fulfills all specifications and boundary conditions. The solution is then optimized to the furthest extent possible with regard to a predetermined quality function. The optimization usually ends when a solution that is known to be optimal has been found, when a solution with a predetermined minimum quality has been found, when the search area has been exhaustively searched or when a predetermined search time has run out.

At one step 340, the determined optimum solution is provided as a production plan 115. In addition, an indication can be respectively derived from variables of the solution on how the production system 105 has to be operated, meaning which product 130, when and with which production means 135, based on which raw material 125 or products 130 must be manufactured.

It is preferred that the determined production plan 115 concerns a predetermined quantity m of time steps that are identical in size, wherein, for each time step, a determination is made concerning which production, storage or transport activities must be carried out. According to a predetermined number of n time steps—wherein n≤m—the determination for m other time steps can be repeated. This principle is also referred to as rolling planning.

FIGS. 4A and 4B show exemplary representations of production plans 115. In FIG. 4A, a production plan 115.1 determined using conventional methods based on a specification for an output to be achieved; is shown, in FIG. 4B, a production plan 115.2 determined using the approach presented herein is shown. In the vertical direction, a runtime of a production means 135 is shown and in the horizontal direction, a time step 405 is shown, respectively. Each time step 405 is one day in the example shown; time steps 405 with a different, in particular, larger expanse are also possible.

On the production plan 115.2, it can be recognized that a predetermined production capacity 410 is not exceeded in any time step 405, which could represent unfulfillable instructions according to the conventional production plan 115.1. Furthermore, the production means 135 at each time step 405 is operated longer than according to conventional production planning 115.1 so that the operational efficiency can be increased and a production time can be shortened.

The production plan 115 is preferably determined for a predetermined number of m time steps 405. A new determination of the production plan 115 can be carried out periodically, wherein in each case actual parameters (e.g. a number of products 130 actually available at a storage facility 165 or production orders actually made) can be used as a basis. The new determination can be executed every n time steps 405, wherein n≤m preferably applies.

Although the invention has been illustrated and described in greater detail with reference to the preferred exemplary embodiment, the invention is not limited to the examples disclosed, and further variations can be inferred by a person skilled in the art, without departing from the scope of protection of the invention.

For the sake of clarity, it is to be understood that the use of “a” or “an” throughout this application does not exclude a plurality, and “comprising” does not exclude other steps or elements.

1. A method to determine a production plan, the method comprising:
identifying production means;
identifying for each production means, at least one product which is manufactured with an aid of the production means;
identifying for each product, at least one raw material that is required for production of each product;
identifying which of the at least one product is used as a raw material for other products;
modeling the identified circumstances as MIP; and
determining a solution to the MIP, which is optimal to the furthest extent possible with regard to at least one predetermined parameter;
wherein the solution indicates which product, at which time should be manufactured with the aid of which production means and based on which raw material.

2. The method as claimed in claim 1, wherein, for each production means, a production capacity utilization is determined in such a way, taking an available production capacity in each time slice for each product into account, that the production capacity of the production means is not exceeded by the sum of the production capacity utilizations of the products.

3. The method as claimed in claim 1, wherein a location is assigned to each production means, each product inventory and each raw material and transporting a raw material or a product from one location to another including the duration required therefor is taken into consideration.

4. The method as claimed in claim 1, wherein at least one storage facility is provided to admit a raw material or product and a capacity is assigned to the storage facility, which must not be exceeded.

5. The method as claimed in claim 3, wherein a location is assigned to the storage facility.

6. The method as claimed in claim 1, wherein a production plan is created for m successively following time steps.

7. The method) as claimed in claim 6, wherein a new production plan is created every n time steps.

8. The method as claimed in claim 6, wherein each time step is at least one day.

9. The method as claimed in claim 1, wherein a maximum shelf-life is assigned to a product and the production plan is created in such a way that the product is processed or provided with a predetermined minimum shelf-life.

10. The method as claimed in claim 1, wherein a predetermined waiting time is assigned to a product-or a raw material the production plan is created in such a way that the product or the raw material is not further processed or provided before the waiting time expires.

11. The method as claimed in claim 1, wherein the solution is determined in such a way that a predetermined minimum production quantity, which indicates what quantity of a product must be at least processed at a production step, is upheld.

12. The method as claimed in claim 1, wherein the solution is determined in such a way that a predetermined batch size, which indicates a quantity of a product, of which an integral multiple must be processed at a production step, is upheld.

13. A computer program product, comprising a computer readable hardware storage device having computer readable program code stored therein, said program code executable by a processor of a computer system to implement a method with program-code means to carry out the method as claimed in claim 1 if it runs on an executing means or is stored on a computer-readable medium.

14. A device to determine a production plan, wherein the device comprises a processing device, which is set up to determine a solution of an MIP based on:
production means;
products respectively assigned to the production means, which can be manufactured with the aid of the production means;
raw materials which are required for the production of the products, assigned to the products; and
dependencies, which report which of the products is used as a raw material for which other product;
wherein the solution is optimized to the furthest extent possible with regard to at least one predetermined parameter and indicates which product at which time should be manufactured with the aid of which production means and based on which raw material.

15. A production system, comprising
a plurality of production means, with the aid of which at least one product can be manufactured from at least one raw material respectively; and
a device as claimed in claim 14.
